(19) United States
(12) Patent Application Publication
(10) Pub. No.: US 2021/0316926 A1
(43) Pub. Date: Oct. 14, 2021

(54) SYSTEM AND PROCESS FOR COOKING FOOD IN A VALVED POUCH

(71) Applicant: Sugar Creek Packing Co., Washington Court House, OH (US)

(72) Inventors: Mark Edward AUERNHEIMER, Henrico, VA (US); Richard Paul CALLADONATO, Ambler, PA (US)

(21) Appl. No.: 16/844,510

(22) Filed: Apr. 9, 2020

(51) Int. Cl. B65D 77/22; A23L 3/015; B65D 81/34; A23L 3/00; A23L 3/02; A47J 27/10

(52) U.S. Cl. CPC B65D 77/225; A23L 3/0155; B65D 81/3415; B65D 81/3438; A23L 3/001; A23V 2300/24; A47J 27/10; B65D 81/3461; B65D 2205/00; A23V 2002/00; A23L 3/02

(57) ABSTRACT

A system and method for cooking food in a valved pouch. In an exemplary embodiment, the system includes a vacuum sealer that vacuum seals uncooked food in the pouch; a cooker that heats the vacuum sealed pouch containing the uncooked food to cook the food; and a control that modulates a cooking temperature and a cooking time at which the cooker cooks the vacuum sealed pouch containing the uncooked food to selectively partially or completely cook the food in the vacuum sealed pouch. The cooking temperature and cooking time are selected such that the valve of the vacuum sealed pouch remains closed in the cooker throughout the cooking time. The valve is selected to open during subsequent retherming of the cooked food in the vacuum sealed pouch to allow steam and/or vapor to escape from the pouch to the ambient.

### TECHNICAL FIELD

The present disclosure relates to systems and processes for cooking and subsequently reheating food in a sealed pouch, and more particularly, to systems and processes for cooking and subsequently reheating and/or retherming food in a vented, sealed pouch.

### BACKGROUND

Many ways have been developed to cook food in a sealed container. Utilizing a sealed container to cook food is popular because it lends itself to mass production, in which predetermined volumes of pre-prepared food are deposited into containers on one or more conveyors and the containers are hermetically sealed. Thereafter, the containers may be chilled or frozen to preserve the food sealed inside. Alternatively, or in addition, food may be cooked while in the sealed containers, or the cooking process completed. In either case, maintaining the prepared food in the sealed container preserves the pasteurization of food and promotes the useful life of the food in the container.

There are many types of packaging that can be sealed to preserve food in addition to placing food in metal cans. For example, food can be placed in bags made of a thin, flexible plastic film. Such bags are sealed by heating, adhesives, and/or crimping. Another option is to place the food in rigid plastic trays or tubs having open tops, then seal the tray or tub by covering the open top with a thin plastic film, forming a peelable seal. The rigid tub in some instances eliminates the need for an additional outer package, thereby minimizing packaging materials, and the plastic tub can be made of a recyclable plastic.

Sealing food in containers in the form of bags or pouches made of a thin plastic film is a popular material for packaging food. Plastic pouches are inexpensive compared to food packages made of other materials, such as metal cans, take up less space, and the plastic pouches permit the food to be stored in the plastic pouch, then cooked or rethermed using hot or boiling water or microwave radiation while in the same plastic pouch.

A popular form of cooking food in plastic bags or pouches is sous vide (“under vacuum”) cooking. With sous vide cooking, food, optionally mixed with spices, flavorings, marinades, and/or sauces, is vacuum sealed in a plastic pouch, then cooked in-pouch in a heated water bath. Typically, the water bath is kept below boiling temperature. Water bath temperature and residence time of the sealed pouches in the heated water bath can be precisely controlled. Vacuum sealing the food in the pouch promotes heat transfer from the water bath through the pouch to the food. Additionally, maintaining the cooked food in a pouch from which air has been removed extends the storage life of the cooked food sealed in the bag.

Sous vide cooking retains juices and aroma in the vacuum sealed pouch that otherwise would be lost in a cooking process. Frequently with sous vide cooking, food products are vacuum-sealed in a food grade plastic pouch and cooked for times that are much longer and at temperatures much lower than for other types of cooking. Sous vide cooking times can vary between 1 to 6 hours, and up to 48 or more hours in some select cases, at water bath temperatures that may vary between 130° F. to 209° F. (55° C. to 98° C.) for animal protein such as meat, and higher for vegetables. Sous vide cooking cooks the food in the pouch evenly, and cooks food thoroughly without overcooking the surface or ends of the food.

After sous vide cooking, the cooked food may be frozen or chilled in-pouch and stored or shipped to a retailer, restaurant, or other food preparation facility. The purchaser can then maintain the cooked food in-pouch chilled or frozen and reheat the food to an appropriate eating temperature when desired, such as by microwave heating or a hot water bath.

A disadvantage with reheating or retherming cooked food stored in-pouch is that the process of reheating or retherming the contents of the pouch causes air and/or moisture within the sealed pouch to expand, which may rupture the pouch and allow the food contents to spill out or to splatter. This undesirable property of in-pouch reheating or retherming is especially acute when reheating or retherming by microwave heating. The unintended of rupturing of the pouch, or of the film covering the top of a rigid plastic tub holding the food, currently is alleviated either by manually poking a hole or making a slit in the pouch with a sharp instrument or partially peeling back the cover film to provide an opening for air, heated moisture, and/or steam to escape.

In addition to the hazards of using a sharp instrument to puncture or slit the plastic of the pouch or cover film, the process of forming such an opening may cause liquid contents to leak out from the pouch or tub. Accordingly, there is a need for a system and a method whereby food can be cooked in a sealed pouch, a sealed tub, or other sealed plastic enclosure and subsequently reheated or rethermed in the same sealed enclosure without the preparer having to manually puncture the plastic to allow air, heated moisture, and/or steam to escape.

### SUMMARY

The disclosed system and method provide a plastic pouch, which may take the form of a plastic bag, a rigid plastic tray covered by a flexible plastic film, or a rigid plastic container covered by a flexible plastic film, or other plastic container that is sufficiently robust to permit the food contents to be partially or fully cooked, then chilled or frozen, then subsequently reheated or rethermed in the same plastic container. The plastic container includes a valve that remains closed during vacuum sealing the food in the pouch, the initial cooking of the pouch, and optionally the subsequent chilling or freezing of the food to in the vacuum sealed pouch to prevent its contamination or premature spoilage. The valve in the pouch subsequently may open during retherming to allow heated air, heated moisture, and/or steam to escape from the interior of the pouch to the ambient. In some embodiments, the valve opens during the subsequent retherming only in response to a pressure differential between the interior of the pouch and the ambient.

In an exemplary embodiment, a system for cooking food includes a pouch having a valve that opens from an interior of the pouch to ambient; a vacuum sealer that vacuum seals uncooked food in the interior of the pouch, resulting in a vacuum sealed pouch containing the uncooked food; a cooker that receives the vacuum sealed pouch containing the uncooked food from the vacuum sealer and heats the vacuum sealed pouch containing the uncooked food; and a control that modulates a cooking temperature and a cooking time at which the cooker heats the vacuum sealed pouch containing the uncooked food to selectively partially or completely cook the food in the vacuum sealed pouch, resulting in the vacuum sealed pouch containing cooked food. The control is programmed to modulate the cooking temperature and the cooking time of the cooker such that the valve remains closed while in the cooker throughout the cooking time and the valve is selected to open during retherming of the cooked food in response to pressure from one or more of heated air, steam, and heated water vapor in the interior of the vacuum sealed pouch to allow the one or more of the heated air, steam, and heated water vapor to escape to the ambient.

In another embodiment, a system for cooking food includes a vacuum sealed pouch that contains uncooked food, the vacuum sealed pouch having a valve that allows escape of one or more of heated air, steam, and heated water vapor from an interior thereof to ambient; a sous vide cooker that receives the vacuum sealed pouch and heats the vacuum sealed pouch and the uncooked food in heated water to selectively partially or fully cook the uncooked food, resulting in a vacuum sealed pouch having cooked food; and a control that controls a temperature of the heated water in the sous vide cooker and a residence time of the vacuum sealed pouch in the sous vide cooker. The valve is selected to remain closed to prevent water from entering the pouch during the entire residence time the vacuum sealed pouch is in the sous vide cooker and open during subsequent retherming of the vacuum sealed pouch having cooked food to allow one or more of heated air, steam, and heated water vapor to escape from the interior thereof to the ambient.

In yet another embodiment, a method for cooking food includes placing uncooked food in a pouch having a valve that allows escape of one or more of heated air, steam, and heated water vapor from an interior thereof to ambient; vacuum sealing the uncooked food in the pouch, resulting in a vacuum sealed pouch containing the uncooked food; heating the vacuum sealed pouch containing the uncooked food from the vacuum sealer to cook the uncooked food in the vacuum sealed pouch; and modulating a cooking temperature and a cooking time of the vacuum sealed pouch containing the uncooked food to selectively partially or completely cook the food in the vacuum sealed pouch, resulting in a vacuum sealed pouch containing cooked food. The cooking temperature and the cooking time are selected such that the valve is closed throughout the cooking time and the valve is selected to open during retherming of the cooked food to allow steam and/or vapor to escape from the interior of the vacuum sealed pouch subsequent to cooking the food by the cooker.

In still another embodiment, a method for cooking and reheating a food product includes vacuum sealing a food product in a pouch having a valve that allows escape of one or more of heated air, steam, and heated water vapor from an interior thereof to ambient; sous vide cooking the food product for a time and at a temperature selected such that the valve remains closed throughout cooking, resulting in a vacuum sealed pouch containing cooked food; optionally refrigerating the vacuum sealed pouch containing cooked food; and retherming the cooked food in the vacuum sealed pouch such that the valve of the vacuum sealed pouch opens to allow escape of the one or more of heated air, steam, and heated water vapor from the interior to the ambient during retherming.

Other objects and advantages of the disclosed system and process for cooking food in a valved pouch will be apparent from the following description, the accompanying drawings, and the appended claims.

### BRIEF DESCRIPTION OF THE DRAWINGS

FIG. 1 is a schematic, perspective view of an exemplary embodiment of food in a valved pouch utilized in the disclosed system and process, in which the pouch is in the form of a vacuum sealed plastic bag with a valve;

FIG. 2 is a schematic, perspective view of another exemplary embodiment of food in a valved pouch utilized in the disclosed system and process, in which the pouch is in the form of a vacuum sealed plastic bag with a valve;

FIG. 3 is a schematic, perspective view of yet another exemplary embodiment of food in a valved pouch utilized in the disclosed system and process, in which the pouch is in the form of a vacuum sealed tub with a plastic cover having valve;

FIG. 4 is a schematic, perspective view of still another exemplary embodiment of food in a valved pouch utilized in the disclosed system and process, in which the pouch is in the form of a tray with a vacuum sealed plastic cover having a valve;

FIG. 5 is a schematic diagram of an embodiment of the disclosed system for cooking food in a valved pouch, for example of the types shown in FIGS. 1-4; and

FIG. 6 is a flow chart of an exemplary embodiment of a disclosed method for cooking food in a valved pouch, for example of the types shown in FIGS. 1-4, utilizing embodiments of the system of FIG. 5.

### DETAILED DESCRIPTION

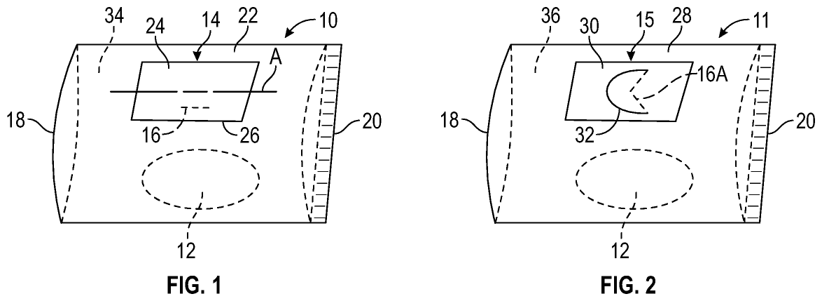

In embodiments, the disclosed system and process utilize valved pouches. Exemplary embodiments of valved pouches utilized with the disclosed system and process, generally designated 10, 11, 40, and 50, are shown in FIGS. 1, 2, 3, and 4, respectively. FIG. 1 shows a pouch 10 in the form of a bag having a closed end 18 and an open end 20 that in embodiments is closed by heat sealing. The pouch 10 is sized to receive food 12 in its interior 34 and includes a valve, generally designated 14. The pouch 10 or material comprising the pouch includes an opening 16 from the ambient to the interior of the pouch. In an embodiment, the opening 16 is in the form of a linear, elongate slit formed through the body or wall, such as a side wall 22 of the pouch 10. In the embodiment of FIG. 1, the valve 14 is created by placing a valve membrane, which in the embodiment takes the form of tape 24 made of a heat-resistant plastic, over the opening 16 on an outside surface of the side wall 22 of the pouch 10 such that it fully covers the opening 16. The tape 24 in embodiments is secured to the wall 22 by a suitable adhesive.

In embodiments, the tape 24 is oblong and rectangular in shape, having opposing long sides and is attached to the outside surface of the side wall 22 such that the elongate slit 16 is parallel to one of the opposing long sides between and is positioned over the opening 16 so that the opening is positioned between a midpoint of the tape, designated by longitudinal centerline A of the tape, and one of the opposing long sides 26 of the tape.

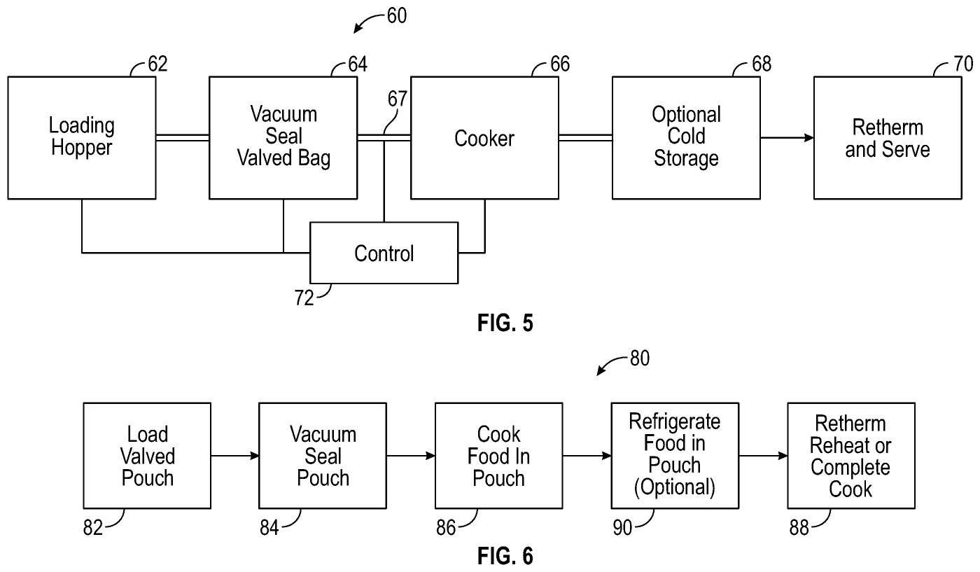

Upon reheating or retherming the pouch 10 a heating device, such as the heating device 70 shown and described with reference to FIG. 5, which in embodiments takes the form of a microwave oven, the pressure from the heated contents in the interior of the pouch 10, which in embodiments includes heated air, steam, and/or heated water vapor given off by the food 12 being heated, creates a pressure differential between the interior of the pouch 10 and the ambient that causes all or a portion of the tape 24 to separate from the wall 22 along the longitudinal edge 26, thus allowing the steam/moisture/air to escape from the interior of the pouch 10 to the ambient. In embodiments, this escape of steam/moisture/air from between the tape 24 and the wall 22 causes an audible whistle indicating that the reheating and/or retherming of the food product is complete.

In the embodiment of FIG. 2, a pouch 11 in the form of a bag similar in construction to the bag or pouch 10 FIG. 1 includes a valve 15. The wall 28 of the pouch 11 has an opening from the ambient to the interior 36 in the form of a slit 16A having a V-shape. The opening 16A is covered by tape 30, which in embodiments is a heat-resistant plastic. The tape 30 includes having a flap 32, in embodiments having a U-shape, cut into it directly over the opening 16A. The flap 32 and/or the adjacent wall 28 includes an adhesive positioned to cause the flap to adhere to the wall and cover the opening. In embodiments, a release coating is applied over at least a part of the adhesive to allow the flap 32 to release and open the valve 15 when the valve is subjected to a preselected pressure differential between the interior 36 and the ambient during retherming of the food 12.

The tape 30 in embodiments is superposed to the slit 16A such that the flap 32 is over the slit. The tape 30 and flap 32 are secured against the wall 28 by an adhesive that is applied to the tape 30, flap 32, and/or wall 28. Upon reheating and/or retherming the food product 12 within the pouch 11, the pressure differential between the heated air, heated moisture, and/or steam in the interior 36 of the pouch 11 and the ambient causes the heated air, heated moisture, and/or steam to exit the interior of the pouch 11 through the opening 16A and cause the flap 32 to separate from the wall 28, thereby allowing steam/moisture/air to escape from the interior of the pouch to the ambient.

The pouches 10, 11 are each sized to receive a food product 12 inside. In an exemplary embodiment, the pouches 10, 11 each have a closed end 18 and an open end 20 that allows insertion of the food product 12. The open end 20 of the pouch 10 is closed using mechanisms known in the art, such as heat welding, thermal sealing, an adhesive, and for pouches 10, 11 made of metal foil such as aluminum, crimping. In other embodiments, the pouches 10, 11 are formed with an open end 18 and a closed end 20. As will be described in greater detail, the open end 20 of the pouch 10, 11 is subsequently sealed as part of a vacuum-sealing process once the food product 12 is inserted. The valves 14, 15 in embodiments are one-way valves that, when closed, do not allow air or fluid to enter from the ambient to the interiors of the pouches 10, 11. In embodiments, the pouches 10, 11 are made of flexible, food grade, heat-resistant, transparent plastic.

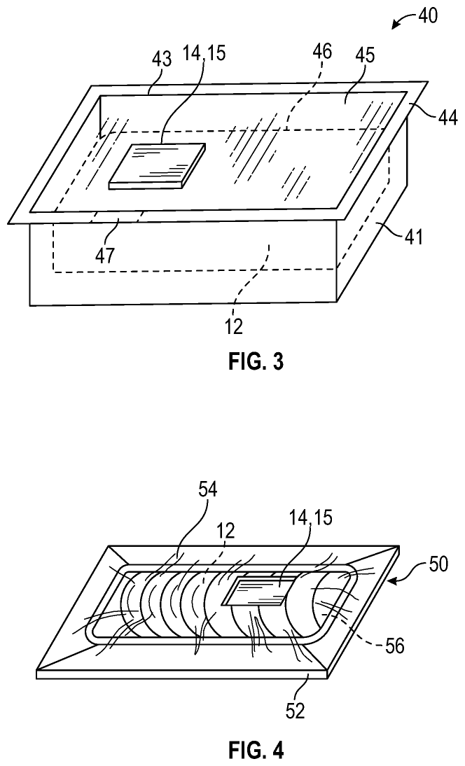

In FIG. 3, in an exemplary embodiment the pouch takes the form of a tub package 40. Tub package 40 includes a lower portion or tub 41. In embodiments, the tub 41 is made of a food grade, oven-safe or oven-ready material, for example able to withstand reheating and/or retherming temperatures of up to 160° F. (71° C.) and heating by microwave radiation. In embodiments, the tub 41 is made of a rigid (i.e., it retains its shape at room temperature and during cooking), heat-resistant plastic, such as crystalline polyethylene terephthalate (CPET). In other embodiments, the tub 41 is made of a material selected from aluminum and coated paperboard.

In embodiments, the tub 41 is cuboid in shape, having opposed parallel sides that meet to form a rectangle in plan view, and in other embodiments the sides meet to form a square. In still other embodiments the tub 41 of the tub package 40 is in other three-dimensional polygonal shapes, such as hexagonal, and curved shapes, such as circular and elliptical. The tub 41 completely holds the food 12 and in embodiments includes an open top 43 bounded by a planar peripheral lip 44 perpendicular to the open top.

A removable cover 45, which in embodiments is a film of flexible food grade plastic, and in some embodiments is wholly or partially transparent, covers the open top 43 of the tub 41 and is adhered to the peripheral lip 44. In other embodiments, the removable cover 45 is made of a polyester film such as Mylar® (a registered trademark of Dupont Teijin Films Limited Partnership of Wilmington, Del.), which withstands reheat and/or retherm temperatures of at least 350° F. (177° C.) and withstands heating by microwave radiation. In embodiments, the cover 45 is adhered to the peripheral lip 44 about the entire periphery of the tub 41 by a suitable adhesive, by heat welding, or a combination of both. The adhesive is selected from adhesives that will not weaken or permit separation of the removable cover 45 from the peripheral lip 44 during the sous vide cooking process. In embodiments, the removable cover 45 takes the form of a peelable seal that is removed from the peripheral lip 44 by a user who grasps a corner of the removable cover and peels it away from the peripheral lip.

In an embodiment, the removable cover 45 includes a one-way valve, such as valve 14 or 15 described with respect to pouches 10, 11 shown in FIGS. 1 and 2, respectively. In an exemplary embodiment, the selected valve 14, 15 opens to allow heated air, moisture, and/or steam to escape from the interior 46 of the tray package 40 to the ambient during reheating and/or retherming of the food product 12 after sous vide cooking. Alternatively, the periphery of the removable cover 45 is adhered to the peripheral lip 44 by an adhesive that is weaker in a selected portion of the peripheral lip, for example portion 47, so that the portion of the removable cover 45 attached to that portion will separate from the peripheral lip at the selected portion to allow escape of heated air, moisture, and/or steam during reheating and/or retherming.

Another embodiment of the pouch, generally designated 50, is shown in FIG. 4 and takes the form of a tray package. The tray package 50 includes a substantially flat, rigid plastic tray 52 that supports the food 12. In embodiments, the tray 52 is made of a material selected from the materials available for the tub 41 of the tub package 40. The food 12 is positioned on the tray 52 and is covered by a thin, flexible plastic film 54 that is adhered to the tray 52 by a suitable adhesive, heat welding, or by encasing the entire tray in the film, in which case the film adheres to itself. The food 12 is enclosed in the interior 56 of the pouch in the form of a tray package 50 between the film 54 and the tray 52. In embodiments, the film 54 includes a valve, for example as either valve 14 or valve 15 of FIGS. 1 and 2, respectively.

Valve 14, 15 in embodiments is a one-way valve that responds to pressure from heated air, steam, and/or heated water vapor from the food 12 heated in the interiors 34, 36, 46, 56 of the pouches 10, 11, 40, and 50, respectively, to open to allow at least a portion of the heated air, steam, and/or heated water vapor to escape from the interiors through the valve to the ambient during retherming. The pouches 10, 11, 40, 50 in one embodiment, remain waterproof across a temperature range of −20° C. to 100° C. (−4° F. to 212° F.; freezer to boiling water) and are capable of conforming closely to the food 12 to allow the pouches to remain submerged for maximum heat transfer, and rate of heat transfer, from the water bath, in the embodiment in which sous vide cooking is employed. The vacuum sealable pouches 10, 11, 40, 50 in embodiments comprise any pouch that can be vacuum sealed, such as by heat sealing in a thermoforming packaging machine. In one embodiment, the vacuum sealable pouches 10, 11 comprise a plastic bag that can be flat, gusseted, or formed into a shape that optimizes its internal dimensions.

As noted, each of the vacuum sealed plastic pouches 10, 11, 40, 50 described herein further comprise a valve 14, 15. In various embodiments, the valve 14, 15 can comprise any valve known in the art, such as a one-way valve, that prevents water from a sous vide water bath during sous vide cooking from entering the vacuum sealed plastic pouch but also permits the escape of steam, heated air, and/or vapor generated within the pouch 10, 11, 40, 50 during subsequent reheating or retherming. In one embodiment, the valve 14 is available from MicVac AB, as described in U.S. Pat. Nos. 9,681,499, 8,911,150, 7,771,768, and 7,051,762, each of which is incorporated by reference herein in its entirety. As described above, a critical parameter of the valve 14 is that it remains closed, so the associated pouch is water-tight or substantially water-tight during sous vide cooking allow the escape of heated air, steam and/or vapor that is generated during the subsequent reheating or retherming process.

In embodiments, the vacuum sealable pouch 10, 11, 40, 50 can be comprised of virtually any waterproof, food grade material and can include but is not limited to plastic, polyolefin, nylon, PET, PEA, PBS, PVDC, biopolymers, silicone polymers, coated fabrics, fiber-based materials, and mixtures thereof. The various materials that can be utilized are selected to provide the desired barrier, strength, and pliability in the temperature range of −20° C. to 100° C. (−4° F. to 212° F.). In one embodiment the material allows for reusability of the vacuum sealable pouch 10 whereas in other embodiments the vacuum sealable pouch is designed for a single use. In embodiments, shown for example in FIGS. 3, and 4, the food product 12 may be provided in the tub package 40 or the tray package 50 in which the food 12 is in or on a rigid support covered with a plastic film on which the valve 14, 15 is arranged. The plastic film of this embodiment equates with the above description of the plastic pouch.

In embodiments, the food 12 is or includes an animal protein, such as beef, pork, lamb, fish, duck, and poultry such as chicken, turkey and goose, and combinations of the foregoing. In other embodiments, the food product is selected from rices, beans, legumes, vegetables, and combinations of the foregoing, as well as food made from plants, such as vegetables, legumes, potatoes, and sweet potatoes, and combinations of the foregoing. In still other embodiments, the food product 12 is a combination of animal protein and food made from plants. In embodiments, the food 12 also includes one or more of a spoilage inhibitor, a predusting of flour, spices, sauce, and marinade mixed with the foregoing. In embodiments, when placed in the pouches 10, 11, 40, 50, the food 12 is solid, liquid, a slurry of solid and liquid, a paste, and combinations of the foregoing.

An exemplary embodiment of the disclosed system for cooking food, generally designated 60, is shown schematically in FIG. 5. That system 60 includes one or more pouches selected from a flexible bag made of plastic film 10, 11, a tub package 40 including a rigid plastic tub 41 covered with a removable cover 45 of a flexible film attached thereto in a peelable seal, and a tray package 50 including a rigid plastic tray 52 covered with a flexible film 54 attached thereto in a peelable seal. Each of the pouches 10, 11, 40, 50 (see FIGS. 1, 2, 3, and 4) has a valve 14, 15 that opens from an interior 34, 36, 46, 56, respectively, of the pouch to ambient. As used herein, the term “ambient” means the environment immediately surrounding the pouch 10, 11, 40, 50. In embodiments, the ambient is the atmosphere immediately surrounding the pouch 10, 11, 40, 50, which is at, below, or above atmospheric pressure and in embodiments can be a gas or a liquid.

The system 60 further includes a vacuum sealer 64 that vacuum seals food 12 in the interior 34, 36, 46, 56 of the pouch 10, 11, 40, 50, respectively, resulting in a vacuum sealed pouch containing the food. In embodiments, the vacuum sealer 64 may take the form of a thermoforming vacuum sealer and a multi-vac. In other embodiments, the vacuum sealer 64 vacuum seals the pouch using a heat weld such as heat weld 20 or other thermal seal for pouches, such as pouches 10, 11 of FIGS. 1 and 2. In still other embodiments, the vacuum sealer 64 seals the pouches 10, 11, 40, 50 by applying an adhesive and/or by crimping. In embodiments in which the pouch takes the form of a tub package 40 having an aluminum tub 41 and paper or sheet plastic lid 45 (FIG. 3), the tub and lid are secured to each other by crimping.

The system 60 includes a cooker 66 that receives the vacuum sealed pouch 10, 11, 40, 50 containing the food 12 from the vacuum sealer 64 and heats the vacuum sealed pouch containing the food. In embodiments, vacuum sealed pouches 10, 11, 40, 50 are conveyed from the vacuum sealer 64 to the cooker 66 by a conveyor 67, which in embodiments takes the form of multiple conveyors. The conveyor 67 in embodiments is operated to transport food 12 in vacuum sealed pouches 10, 11, 40, 50 from vacuum sealer to be cooked in the cooker 66 in batch mode. In other embodiments, the conveyor 67 transports pouches 10, 11, 40, 50 to the cooker 66 continuously. In embodiments, the system 60 includes a control 72 that modulates the cooking temperature and the cooking time (i.e., the residence time of each individual pouch 10, 11, 40, 50 in the cooker 66) at which the cooker heats vacuum sealed pouches 10, 11, 40, 50 containing the food 12 to selectively partially or completely cook the food in the vacuum sealed pouches, resulting in the vacuum sealed pouches containing cooked food. In embodiments, the cooker 66 receives raw and/or uncooked food 12 in the vacuum sealed pouches 10, 11, 40, 50 and partially or completely cooks the food in pouch. In other embodiments, the food 12 is partially or completely cooked, blanched, and/or seared before being vacuum sealed in one or more of the pouches 10, 11, 40, 50.

In embodiments, the control 72 is programmed to modulate the cooking temperature and the cooking time of the cooker 66 such that the valve 14, 15 remains closed while in the cooker throughout the cooking time. In embodiments, the control 72 is programmed to maintain the cooking temperature of the cooker 66 below the boiling point of water so that the liquid component of the food 12 does not boil and/or steam is not generated from the liquid components of the food in the pouches 10, 11, 40, 50. In an embodiment, the system 60 includes a control 72, which may take the form of a programmable logic controller (PLC) or is part of a computer system and/or network, such as a control area network (CAN). The controller 72 controls and coordinates the operation of the conveyor 67, loading hopper 62, vacuum sealer 64, and/or cooker 66, which in some embodiments is a sous vide cooker. In the latter case, the control 72 regulates the sous vide cooker 56 to modulate the temperature of the sous vide heated cooking bath, such as water, to provide precise control of cooking time and temperature profile.

In embodiments, pouches 10, 11, 40, 50, used with the system 60 include valves 14, 15 selected to open during a subsequent retherming of the cooked food a retherming device 70, such as a microwave oven. During such a retherming, which in some embodiments is shorter in duration than the cooker 66 cooks the food 12, the temperature of the food is raised to or exceeds the boiling point of water, generating heated air, heated moist air, and/or steam in the interior 34, 36, 46, 56 of the pouch 10, 11, 40, 50, respectively, thereby raising the pressure within the vacuum sealed pouch to exceed the pressure of the ambient. In embodiments, the pressure of the ambient is atmospheric pressure. In response, and in embodiments solely in response, to the pressure differential across the valve 14, 15 from one or more of the heated air, steam, and heated water vapor in the interior 34, 36, 46, 56 of the vacuum sealed pouch 10, 11, 40, 50, the valve opens to allow the one or more of the heated air, steam, and heated water vapor to escape to the ambient.

Optionally, the system 60 includes a cold storage 68 that receives the vacuum sealed pouch 10, 11, 40, 50 containing the partially or completely cooked food 12. The cold storage 68 in embodiments chills or freezes the partially or completely cooked food 12 in the vacuum sealed pouch 10, 11, 40, 50. In embodiments, the cold storage 68 receives the pouches 10, 11, 40, 50 of cooked food 12 from the cooker 66 by conveyor 67 and/or manually.

In embodiments, the cooker 66 of the system 60 is selected from a sous vide cooker, a convection oven, an oven using steam, a steam tunnel, a steam spiral, an air oven, and an oven using a heated water shower to heat the vacuum sealed pouches 10, 11, 40, 50 of uncooked food 12. In some embodiments, the controller 72 is programmed to actuate the cooker 66 to heat the pouches 10, 11, 40, 50 with the cooker 66 for a discrete cooking cycle comprised of a plurality of different temperatures in which the cooker 66 holds each of the different selected temperatures for a selected time interval. In an embodiment, the control 72 actuates the cooker 66 to maintain the temperature to which the food 12 is heated to below the boiling point of the liquid in the pouches 10, 11, 40, 50 and/or below the temperature that would otherwise generate steam, heated air, or heated moist air within the interiors 34, 36, 46, 56 of the pouches 10, 11, 40, 50 to a pressure that would cause the valve 14, 15 to open. In embodiments of the system 60, the cooker 66 cooks the food entirely at ambient pressure.

In embodiments of the system 60 in which the cooker 66 is a sous vide cooker the sous vide cooker heats the vacuum sealed pouches 10, 11, 40, 50 containing the food 12 in a heated water bath. In the embodiment of the system 60, in which the cooker 66 is in the form of a sous vide cooker, the control 72 modulates the temperature of the liquid water bath to remain below the boiling point of the liquid throughout the entire cooking process or cycle that fully or partially cooks the food 12, which is the entire residence time of the pouches 10, 11, 40, 50 within the cooker 66. The hydrostatic pressure of the liquid bath, in embodiments a heated water bath, also acts to hold the valve 14, 15 closed during the residence time of the pouches 10, 11, 40, 50 in the cooker 66.

In various embodiments in which the cooker 66 is a sous vide cooker, the sous vide cooker can be any sous vide cooker, and may also be referred to as a cooking bath and refers to any object can hold a volume of cooking fluid at a specified and controlled cooking temperature. One example of a sous vide cooker is described in U.S. Pat. No. 9,603,477, which is incorporated herein in its entirety. The cooking fluid can comprise any cooking liquid such as oil, water, etc. In one embodiment, the cooking fluid comprises water. In one embodiment the cooking bath comprises a heating element (incorporated into cooker 66) that is controlled by the controller 72 to ensure that the cooking bath is maintained at the cooking temperature. In another embodiment the cooking bath has a circulator (incorporated into cooker 66) whereby the cooking fluid is circulated to ensure a desired temperature uniformity within the cooking bath. As noted, the cooking bath maintains the cooking fluid within a specified and controlled cooking temperature by the control 72, which in embodiments is integral with the sous vide cooker 66.

The cooking temperature of the cooker 66, which in embodiment is the bath of the sous vide cooker, will vary depending upon the food 12 to be cooked. In one embodiment the cooking temperature is less than 100° C. (212° F.). As an example, for a food 12 including a steak to be cooked to medium rare, in one embodiment, the cooking temperature is set around 58° C. (136° F.). Conversely, food 12 including dark meat chicken is cooked at a cooking temperature of about 75° C. (167° F.). With the chicken example, the cooking fluid in the sous vide cooker 66 is held at a temperature of about 75° C. (167° F.). This means the desired final temperature of the chicken is 75° C. (167° F.). Accordingly, the chicken is never exposed to a temperature greater than the desired final cooking temperature of the food. If cooked at the cooking temperature for the required cooking time, then the entirety of the food 12, including the center of the food, will have reached the desired internal temperature.

This is contrasted with conventional cooking whereby the external surfaces of food are exposed to temperatures far exceeding the desired final internal temperature. Therefore, conventional cooking results in a final product that has a gradient: the external surface will be well done, then it gradually changes to less done, medium, and then ending with a medium rare center. Conversely, cooking with the method discussed herein results in uniform cooking through the food 12. If the preparer desires a medium rare steak, then the entire cross-section of a steak, for example, will comprise a medium rare color and texture. In embodiments, the loading hopper 62 also sears, browns, and/or forms grill marks on the protein, such as beef, pork, or chicken, before the food product is vacuum sealed in pouch 10, 11, 40, 50 and sous vide cooked in sous vide cooker 66.

As noted, the food 12 is maintained in the cooker 66, which in embodiments takes the form of the cooking bath in a sous vide cooker, at an operator-selected cooking temperature, which in embodiments is selected from a uniform cooking temperature and a program of different cooking temperatures and cooking times, which in embodiments is selected from a single time period and multiple cooking times at different sous vide bath temperatures. The cooking time is the time necessary to ensure the food 12 reaches the desired internal temperature, which in embodiments meets applicable food safety standards. As with the cooking temperature, the required cooking time varies with the food 12 and the cooking temperature. For example, the chicken discussed above requires a cooking time of between about 1 hour and 3 hours. The cooking time, combined with the cooking temperature, ensures the food 12 is cooked to the desired internal temperature. This provides the benefit of killing bacteria and other pathogens that can accompany raw or undercooked food. The benefit is achieved because the entirety of the food 12 reaches the desired internal temperature. This is contrasted to other types of cooking whereby even increasing the temperature to the outer surface of the food 12 may not increase the internal temperature to the desired levels.

As shown in FIG. 5, the system 60 optionally includes a loading hopper 62 that receives, for example manually or by a conveyor, the food 12 that in embodiments is in an uncooked or partially cooked or otherwise unfinished state and conveys the uncooked food to the vacuum sealer 64 to be vacuum sealed in the pouches 10, 11, 40, 50, for example by conveyor 67. In embodiments, the loading hopper 62 adds one or more of a spoilage inhibitor, a predusting of flour, spices, sauce, and marinade directly to the uncooked food that is conveyed from the food hopper to the vacuum sealer 64. Alternatively, or in addition, the loading hopper 62 adds one or more of a spoilage inhibitor, a predusting of flour, spices, sauce, and marinade directly into the pouch 10, 11, 40, 50 in the vacuum sealer 64 that receives the uncooked food 12, optionally from the loading hopper. In still other embodiments, the loading hopper 62 sears and/or applies grill marks to the food 12 that is conveyed from the food hopper to the vacuum sealer 64.

In embodiments, the system 60 incorporates pouches 10, 11, 40, 50 made of a material suitable for retherming the cooked food 12 therein in a microwave oven. In some embodiments, the vacuum sealed pouches 10, 11, 40, 50 of partially or fully cooked food 12 are removed from the cold storage 68 and transported directly to an end user, who may be a restaurant or other food service facility, which may be an institutional or commercial food service facility; in other embodiments, the vacuum sealed pouches are transported directly to a retailer or wholesaler, for further distribution to the end user. The end user reheats or retherms the vacuum sealed pouches 10, 11, 40, 50 in a heating device 70, which in embodiments is a microwave oven, and in other embodiments is a radiant oven or a convection oven.

In an exemplary embodiment, a system 60 for cooking food 12 includes a vacuum sealed pouch 10, 11, 40, 50 that contains uncooked food 12, the vacuum sealed pouch having a valve 14, 15 that allows escape of one or more of heated air, steam, and heated water vapor from an interior thereof to ambient. The vacuum sealed pouch 10, 11, 40, 60 in embodiments is prepared elsewhere and received in the facility for cooking. A sous vide cooker 66 receives the vacuum sealed pouch 10, 11, 40, 50 and heats the vacuum sealed pouch and the uncooked food 12 in heated water to selectively partially or fully cook the uncooked food, resulting in a vacuum sealed pouch having cooked food. The system includes a control 72 that controls a temperature of the heated water in the sous vide cooker 66 and a residence time of the vacuum sealed pouch 10, 11, 40, 50 in the sous vide cooker. The valve 14, 15 in the pouch 10, 11, 40, 50 is selected to remain closed to prevent water from entering the pouch during the entire residence time the vacuum sealed pouch is in the sous vide cooker 66 and open during subsequent retherming of the vacuum sealed pouch 10, 11, 40, 50 having cooked food 12 to allow one or more of heated air, steam, and heated water vapor to escape from the interior thereof to the ambient.

As shown in FIG. 6, in an exemplary embodiment, the system 60 incorporates a method, generally designated 80, for cooking food. As indicated in block 82, the method begins by placing uncooked food 12 in a pouch 10, 11, 40, 50 (see FIGS. 1, 2, 3, and 4) having a valve 14, 15 that allows escape of one or more of heated air, steam, and heated water vapor from an interior thereof 34, 36, 46, 56 to ambient. In an exemplary embodiment, the food 12 is, or includes constituents that are raw and uncooked. In other embodiments, the food 12 is, or may include constituents that are partially cooked, par cooked (e.g., meat such as bacon), and/or are fully pre-cooked (e.g. sauces). In an embodiment in which the pouch takes the form of a tub package 40, the tub 41 is filled with food 12 sufficiently close to the removable cover 45 to permit vacuum sealing the tub package so that the removable cover contacts the food in the tub package.

Optionally, the food 12 to be cooked and rethermed is first deposited into a loading hopper 62 (FIG. 5) either manually or by automated means. In the loading hopper 62, the food 12 in embodiments is vacuum tumbled with a coating selected from flour, spices, liquid marinade, and combinations of the foregoing. In other embodiments, the food 12 is coated with a coating that consists of or includes a spoilage inhibitor. The food 12 is then vacuum sealed in the pouch, resulting in a vacuum sealed pouch containing the uncooked food, as indicated in block 84. In embodiments, the uncooked food 12 is conveyed from the loading hopper 62 to a sealing machine 64, which in embodiments takes the form of a vacuum sealing machine such as a thermoforming vacuum sealing packaging machine. The sealing machine 64 seals the food product 12 in the pouches 10, 11, 40, 50, in embodiments vacuum sealing the food product 12 in the pouches 10, 11, 40, 50.

The process 80 continues, as indicated in block 86, with heating the vacuum sealed pouch 10, 11, 40, 50 containing the food 12 from the vacuum sealer 64 to cook the food in the vacuum sealed pouch. In embodiments, the sealed pouches 10, 11, 40, 50 of food 12 are conveyed from the sealing machine 64 to a cooker 66, where the food is cooked. In embodiments, the cooker 66 is operated in a batch mode; in other embodiments, the vacuum sealed pouches 10, 11, 40, 50 of food 12 are conveyed through the cooker 66 continuously by the conveyor 67, which may take the form of a plurality of conveyors operating in parallel, arranged side by side and/or parallel. In still other embodiments, the conveyor 67 takes the form of a continuous conveyor beginning at the loading hopper 62 and passing through the vacuum sealer 64 before passing through the cooker 66.

During the cooking indicated in block 86, the cooking temperature and cooking time of the vacuum sealed pouch 10, 11, 40, 50 containing the food 12 are modulated by the control 72 to selectively partially or completely cook the food in the vacuum sealed pouch, resulting in a vacuum sealed pouch containing cooked food. In exemplary embodiments, cooking temperatures may range from 130° F. to 205° F. (54° C. to 96° C.), and in some applications, including a cooker 66 in the form of a dry oven, up to 210° F. (99° C.). The cooking temperature is selected to keep the temperature of the food 12 in the pouches 10, 11, 40, 50 below boiling, or below a temperature at which the pressure in the interiors 34, 36, 46, 56 of the pouches does not exceed ambient pressure to the point where the valves 14, 15 open. The cooking temperature and the cooking time are selected such that the valve 14, 15 remains closed throughout the cooking time and the valve is selected to open during retherming of the cooked food, indicated in block 88, to allow heated air, steam and/or heated water vapor to escape from the interior 34, 36, 46, 46 of the vacuum sealed pouch 10, 11, 40, 50 subsequent to cooking the food by the cooker 66.

In another embodiment of the method 80 shown in FIG. 6, the method for cooking and reheating food 12 begins by vacuum sealing the food product in a pouch 10, 11, 40, 50 having a valve 14, 15 that allows escape of one or more of heated air, steam, and heated water vapor from an interior 34, 36, 46, 56 thereof to ambient, as indicated in block 82. As indicated in block 84, the process 80 continues with cooking the food product in a sous vide cooker 66 at a time and temperature selected such that the valve 14, 15 remains closed throughout cooking, resulting in a vacuum sealed pouch 10, 11, 40, 50 containing cooked food 12.

In an embodiment, the sealed pouches 10, 11, 40, 50 of food product 12 are conveyed from the vacuum sealing machine 64 to a sous vide cooker 66, where the food product is sous vide cooked. In embodiments, the sous vide cooker 66 is operated in a batch mode; in other embodiments, the vacuum sealed pouches 10, 11, 40, 50 of food product 12 are conveyed through the sous vide cooker continuously by a conveyor 67, which may take the form of a plurality of conveyors operating in parallel and arranged horizontally and/or vertically. In still other embodiments, the conveyor 67 takes the form of a continuous conveyor beginning at the loading hopper 62 and passing through the vacuum sealer 64 and then the cooker 66.

After the food 12 has been cooked (i.e., partially or fully cooked to the desired degree of completeness) in the cooker 66, the process continues with refrigerating the vacuum sealed pouch 10, 11, 40, 50 containing cooked food 12, as indicated in block 90, where the pouches are kept chilled or frozen, either for subsequent reheating or shipment to an end user. In a more general embodiment, the partially or fully cooked food 12 in the vacuum sealed plastic pouch 10, 11, 40, 50 is then maintained in an environment that promotes longevity of the cooked food 12, such as refrigeration or freezing, as is known in the art, such as in cold storage 68.

Then, as indicated in block 88, when a consumer desires to eat the cooked food product 12, the food product is rethermed in the vacuum sealed pouch 10, 11, 40, 50 by any means conventional in the art, such as microwave heating by microwave 70. Retherming includes reheating the food 12 to an acceptable eating temperature, and in other embodiments heating the food to complete the cooking of the food and raise the temperature of the food to an acceptable eating temperature. During retherming, once the heated air, steam, and/or vapor pressure exceeds the adhesive force of the valve 14, 15, the valve opens, thus allowing the escape of the heated air, steam, moisture and/or vapor from the interior 34, 36, 46, 56 of the pouch 10, 11, 40, 50, to the ambient.

In some embodiments, retherming the cooked food 12 in the vacuum sealed pouch 10, 11, 40, 50 includes retherming the cooked food in the vacuum sealed pouch by microwave radiation, as in a microwave oven 70. The microwave oven 70 may take the form of a standalone microwave oven that sequentially receives a vacuum sealed pouch or pouches 10, 11, 40, 50, and in other embodiments takes the form of a microwave tunnel in which a conveyor continuously transports the vacuum sealed pouches through one or more microwave radiation chambers where they are rethermed.

In embodiments, retherming in block 88 is selected from reheating the cooked food 12 in the vacuum sealed pouch 10, 11, 40, 50 and completing the cooking of the cooked food in the vacuum sealed pouch. In other embodiments, retherming of the cooked food 12 in the vacuum sealed pouch 10, 11, 40, 50 in block 88 causes a pressure differential between the interior 34, 36, 46, 56 and the ambient that opens the valve 14, 15 to allow the escape of the one or more of heated air, steam, and heated water vapor from the interior to the ambient, and this pressure differential is the sole mechanism for opening the valve.

In the foregoing described embodiments, the valves 14, 15 of pouches 10, 11, 40, 50 remain completely closed during cooking, in embodiments sous vide cooking in the sous vide cooker 66, due in part to the adhesive securement of the tape 24 to the adjacent wall 22 of the pouch 10, for example and the flap 32 of tape 30 to the adjacent wall 28 of the pouch 11, for example. In embodiments involving sous vide cooking, the valve 14, 15 is also held closed in part because of the pressure differential across the valves between the heated liquid of the sous vide cooker and the contents of the pouch 10, 11, 40, 50, which in embodiments is vacuum sealed. The securing mechanism for valves 14, 15, which in embodiments is a water-resistant adhesive, is selected to remain closed during sous vide cooking, yet yield and open during subsequent retherming, as by microwave cooking in a microwave 70 (FIG. 5). In embodiments, the tape 24, 30 of the valves 14, 15, respectively, is selected from a one-layer membrane, although one or several layers may be employed at the choice of the user and their needs.

In order to modify the adhesion of the valve 14, 15 to the plastic film of the pouch 10, 11, 40, 50 such as an adhesion that allows the valve to remain closed during cooking in sous vide cooker 66 but can be opened due to the pressure build-up caused by subsequent retherming in a heating device 70 such as a microwave, in embodiments a release coating is placed on an area of the adhesive in order to reduce the adhesion to the film of the wall 22, 28, 45, 54 of pouches 10, 11, 40, 50, respectively. In an exemplary embodiment of the invention this is achieved by printing the release coating on the desired area of the tape 24, 30 of valve 14, 15. Thereafter the tape 24, 30 is placed on the plastic film wall 22, 28, 45, 54 of the associated pouch 10, 11, 40, 50 after forming the slit 16, 16A, respectively, constituting the opening.

As described above, the sous vide cooking requires the food product to be contained within a vacuum sealed container or pouch 10. The exclusion of air from the pouch 10 is not essential for cooking but has advantages. It allows cooked food to be stored longer. Another advantage of using a vacuum sealed cooking bag is the exclusion of oxygen. Reducing oxidation during the extended cooking time can be particularly important for cooking meat, for example, because the fat may become rancid with prolonged exposure to oxygen in the air at elevated temperature. Reducing the level of oxygen also dramatically decreases the opportunity for aerobic bacteria growth in the food. In addition, the vacuum condition reduces the tendency of the sealed bags to float and improves the heat transfer efficiency across the pouch 10 between the cooking fluid and the food product 12.

As described above, cooking represented in block 86 (FIG. 6) requires the food product 12 to be contained within a vacuum sealed container or pouch 10, 11, 40, 50. The exclusion of air from the pouch 10, 11, 40, 50 in some embodiments is not essential for cooking the food 12 contained in the interior 34, 36, 46, 56 but has some advantages. Vacuum sealing the pouches 10, 11, 40, 50 allows cooked food to be stored longer. Another advantage of using a vacuum sealed cooking pouch 10, 11, 40, 50 is the exclusion of oxygen, which reduces oxidation during the extended cooking time and is particularly important for cooking meat, for example, because the fat may become rancid with prolonged exposure to oxygen in the air at elevated temperature. Reducing the level of oxygen also dramatically decreases the opportunity for aerobic bacteria growth in the food. In addition, vacuum sealing the food 12 in the pouches 10, 11, 40, 50 removes air spaces or voids that may exist between the food and the associated pouches so that there is direct contact between the outer surface of the food and the pouches, which maximizes heat transfer from the ambient through the pouch to the food.

While the forms of systems and processes described herein represent preferred embodiments of the disclosed system and process for cooking food in a valved pouch, it is to be understood that the invention is not limited to these precise processes and systems, and that changes may be made therein without departing from the scope of the invention.

What is claimed is:

1. A system for cooking food, the system comprising:
a pouch having a valve that opens from an interior of the pouch to ambient;
a vacuum sealer that vacuum seals food in the interior of the pouch, resulting in a vacuum sealed pouch containing the food;
a cooker that receives the vacuum sealed pouch containing the uncooked food from the vacuum sealer and heats the vacuum sealed pouch containing the food; and
a control that modulates a cooking temperature and a cooking time at which the cooker heats the vacuum sealed pouch containing the food to selectively partially or completely cook the food in the vacuum sealed pouch, resulting in the vacuum sealed pouch containing cooked food;
wherein the control is programmed to modulate the cooking temperature and the cooking time of the cooker such that the valve remains closed while in the cooker throughout the cooking time; and
wherein the valve is selected to open during retherming of the cooked food in the vacuum sealed pouch containing cooked food in response to pressure from one or more of heated air, steam, and heated water vapor in the interior of the vacuum sealed pouch to allow the one or more of the heated air, steam, and heated water vapor to escape to the ambient.

2. The system of claim 1, further comprising a cold storage that receives the vacuum sealed pouch containing the cooked food that chills or freezes the partially or completely cooked food in the vacuum sealed pouch.

3. The system of claim 1, wherein the cooker is selected from a sous vide cooker, a convection oven, an oven using steam, a steam tunnel, a steam spiral, an air oven, and an oven using a heated water shower to heat the vacuum sealed pouch of uncooked food.

4. The system of claim 3, wherein the sous vide cooker heats the vacuum sealed pouch containing the food in a heated water bath.

5. The system of claim 4, wherein the control modulates the temperature of the water bath to remain below a boiling point of the water bath.

6. The system of claim 1, wherein the cooker cooks the food entirely at ambient pressure.

7. The system of claim 1, wherein the pouch is selected from a flexible bag made of plastic film, a tub package including a rigid plastic tub covered with a flexible film attached thereto in a peelable seal; and a tray package including a rigid plastic tray covered with a flexible film attached thereto.

8. The system of claim 7, wherein the flexible bag includes a side wall having the valve thereon.

9. The system of claim 7, wherein the flexible film of the tub package includes the valve.

10. The system of claim 7, wherein the flexible film of the tray package includes the valve.

11. The system of claim 1, wherein the food is selected from animal protein, rices, beans, legumes, vegetables, and combinations of the foregoing.

12. The system of claim 1, further comprising a loading hopper that receives the food in an uncooked state and conveys the uncooked food to the vacuum sealer to be vacuum sealed in the pouch.

13. The system of claim 12, wherein the loading hopper adds one or more of a spoilage inhibitor, a predusting of flour, spices, sauce, and marinade directly to the uncooked food that is conveyed from the food hopper to the vacuum sealer and/or to the pouch that receives the uncooked food from the loading hopper.

14. The system of claim 12, wherein the loading hopper sears and/or applies grill marks to the food that is conveyed from the food hopper to the vacuum sealer.

15. The system of claim 1, wherein the pouch is made of a material suitable for retherming the cooked food in a microwave oven.

16. The system of claim 1, wherein the pouch includes a side wall having an opening from the ambient to the interior; and the valve includes tape covering the opening.

17. The system of claim 16, wherein the tape is attached to an outside surface of the side wall over the opening.

18. The system of claim 16, wherein the opening includes an elongate slit.

19. The system of claim 16, wherein the tape oblong in shape, having opposing long sides, and is attached to the outside surface of the side wall such that the elongate slit is parallel to one of the opposing long sides between a midpoint of the tape and the one of the opposing long sides.

20. The system of claim 1, wherein the pouch includes a wall having an opening from the ambient to the interior and the flap, and further includes an adhesive on the flap and/or the wall positioned to cause the flap to adhere to the wall and cover the opening.

21. The system of claim 20, wherein a release coating is placed over at least a part of the adhesive to allow the flap to release and open the valve when the valve is subjected to a preselected pressure differential between the interior and the ambient during retherming.

22. A system for cooking food, the system comprising:
a vacuum sealed pouch containing food, the vacuum sealed pouch having a valve that allows escape of one or more of heated air, steam, and heated water vapor from an interior thereof to ambient;
a sous vide cooker that receives the vacuum sealed pouch containing food and heats the vacuum sealed pouch and the food in heated water to selectively partially or fully cook the food, resulting in a vacuum sealed pouch having cooked food;
a control that controls a temperature of the heated water in the sous vide cooker and a residence time of the vacuum sealed pouch in the sous vide cooker; and
the valve is selected to remain closed to prevent water from entering the pouch during the entire residence time the vacuum sealed pouch is in the sous vide cooker and open during subsequent retherming of the vacuum sealed pouch having cooked food to allow one or more of heated air, steam, and heated water vapor to escape from the interior thereof to the ambient.

23. A method for cooking food, the method comprising:
placing uncooked food in a pouch having a valve that allows escape of one or more of heated air, steam, and heated water vapor from an interior thereof to ambient;
vacuum sealing the uncooked food in the pouch, resulting in a vacuum sealed pouch containing the uncooked food;
heating the vacuum sealed pouch containing the uncooked food from the vacuum sealer to cook the uncooked food in the vacuum sealed pouch; and
modulating a cooking temperature and a cooking time of the vacuum sealed pouch containing the uncooked food to selectively partially or completely cook the food in the vacuum sealed pouch, resulting in a vacuum sealed pouch containing cooked food;
wherein the cooking temperature and the cooking time are selected such that the valve is closed throughout the cooking time; and
wherein the valve is selected to open during retherming of the cooked food to allow heated air, steam and/or vapor to escape from the interior of the vacuum sealed pouch subsequent to cooking the food by the cooker.

24. A method for cooking and reheating food, the method comprising:
vacuum sealing a food in a pouch having a valve that allows escape of one or more of heated air, steam, and heated water vapor from an interior thereof to ambient;
sous vide cooking the food in a heated liquid bath for a time and at a temperature selected such that the valve remains closed throughout cooking, resulting in a vacuum sealed pouch containing cooked food; and
retherming the cooked food in the vacuum sealed pouch such that the valve of the vacuum sealed pouch opens to allow escape of the one or more of heated air, steam, and heated water vapor from the interior to the ambient during retherming.

25. The method of claim 24, wherein retherming the cooked food in the vacuum sealed pouch includes retherming the cooked food in the vacuum sealed pouch by microwave radiation.

26. The method of claim 24, wherein retherming is selected from reheating the cooked food in the vacuum sealed pouch and completing the cooking of the cooked food in the vacuum sealed pouch.

27. The method of claim 24, wherein the retherming of the cooked food in the vacuum sealed pouch causes a pressure differential between the interior and the ambient that opens the valve to allow the escape of the one or more of heated air, steam, and heated water vapor from the interior to the ambient.

28. The method of claim 24, further comprising refrigerating the vacuum sealed pouch containing cooked food prior to retherming.
